(19) United States
(12) Patent Application Publication
(10) Pub. No.: US 2023/0295057 A1
(43) Pub. Date: Sep. 21, 2023

(54) COATING CONTAINING MICRONUTRIENTS FOR FERTILIZER GRANULES

(71) Applicant: The Mosaic Company, Plymouth, MN (US)

(72) Inventors: Michael MCLAUGHLIN, Montacute (AU); Roslyn BAIRD, Aberfoyle Park (AU); Shervin KABIRI, Payneham South (AU); Jozefien DEGRYSE, Parkside (AU); Rodrigo Coqui da Silva, Redwood Park (AU)

(21) Appl. No.: 18/041,376

(22) PCT Filed: Aug. 12, 2021
(86) PCT No.: PCT/US2021/045661

§ 371 Date: Feb. 10, 2023

Related U.S. Application Data
(60) Provisional application No. 63/064,550, filed on Aug. 12, 2020.

(51) Int. Cl. C05G 5/30; C05G 5/12; C05D 9/02; C05G 3/20; C05G 3/40; C05G 3/30

(52) U.S. Cl. CPC C05G 5/38; C05G 5/12; C05D 9/02; C05G 3/20; C05G 3/40; C05G 3/30

(57) ABSTRACT

A wax-based coating for fertilizer granules capable of supplying micronutrients to soil while increasing the surface hydrophobicity and abrasion resistance of the fertilizer granules is disclosed. The wax-based coating provides the flexibility of formulating slow and fast releasing micronutrients, and ensures micronutrients are evenly coated across every fertilizer granule. Single or multi-nutrient combinations of coatings are possible, providing formulation flexibility.

### RELATED APPLICATION

The present application claims the benefit of U.S. Provisional Application No. 63/064,550 filed Aug. 12, 2020, which is hereby incorporated herein in its entirety by reference.

### TECHNICAL FIELD

Embodiments of the present disclosure relate generally to coatings for fertilizer and seed products. More specifically, the present disclosure relates to coatings containing micronutrients for seeds, fertilizer granules, fertilizer pellets, and fertilizer prills.

### BACKGROUND

The fertilizer industry has a long-established history of employing coatings to reduce dustiness during handling and caking during storage. As early as 1964, studies suggested it was possible to incorporate micronutrients into granular fertilizers by adding oil, wax, or other binders to stick the fine micronutrient materials onto the surface of the granules. (See, for example, Hignett, T. P. 1964, Com. Fertilizer 108, No. 1, 23-25) Wax coatings were recognized as an effective binder for reducing the rate of nutrient release, for example as disclosed by U.S. Pat. No. 3,192,031 to Zaayenga (hereinafter “Zaayenga”). However, the aliphatic and hydrophobic nature of these binders prevented them from establishing a tenacious coating on the surface of fertilizer granules and taught against their use as an industry practice. (See, e.g., U.S. Pat. No. 5,152,821 to Walter (1992))

In addition, when wax coatings were used to slow the nutrient release, the wax content of the coated fertilizer was typically tailored to the expected rainfall in the area, ranging, for example, from about 20 weight % in areas with relatively little rainfall to about 50 weight % in areas with relatively heavy rainfall. However, as discussed in Zaayenga, this drastically increased production costs and reduced the versatility of potential applications. As an alternative, Zaayenga suggested applying a precoating comprising an inert material such as diatomaceous earth. However, these methods also increased production costs and reduced the versatility of potential applications.

In addition to fertilizer macronutrients like nitrogen, phosphorus, and potassium, secondary nutrients and micronutrients are also essential for crop nutrition. Micronutrients need to be applied in relatively small amounts compared to secondary nutrients and macronutrients. To keep application costs low for farmers, the spreading of both macronutrients and micronutrients at the same time would be ideal. However, the rates required are very different. For example, P may be required and applied to fields at a rate of 60 kg/ha (273 kg/ha as mono ammonium phosphate, or “MAP”) at the same time as 0.5 kg/ha boron (2.3 kg/ha anhydrous borax fertilizer) along with other trace amounts of nutrients such as copper, manganese, molybdenum, iron, and zinc.

The particle size of micronutrient-only fertilizers is sometimes much smaller than granulated macronutrient fertilizer granules, so that when these fertilizers are physically blended together it is not possible to ensure an even distribution in the field because of both the difference in application rate and their separation by segregation during handling, transport, and spreading. These blends inevitably often result in higher dust loadings through handling and can result in health and safety issues as a consequence. To combat this, alternatives such as incorporation of micronutrients into macronutrient fertilizers have been achieved for a small number of micronutrients but this limits the fertilizer in providing for the different nutrient requirements of a diverse range of crops and soils.

Alternatively, coatings have been produced to deliver more flexible combinations of micronutrients. Some coatings have micronutrients added as fine dry powders. For example, U.S. Pat. No. 7,445,657 to Green discloses a dry powder containing micronutrients mixed with dry fertilizer granules to eliminate the need for drying agents. However, adhesion of these particles would need to be exceedingly strong to withstand the abrasion and subsequent degradation of the coating through handling and transport without dust generation.

Other coatings are suspensions of micronutrients in oil carriers. For example, U.S. Pat. No. 10,118,867 to Ward et al. discloses the use of oils and dispersing agents to suspend micronutrients for coatings. Because oils are liquids at all handling temperatures, there is always a risk that if not applied correctly the coated product will be sticky and hard to handle as the surface will not harden. This stickiness can be dependent on the porosity of the underlying granule or prill as surface absorption of the oils will vary.

Oils are used as the base of many coatings due to their low cost. However, their effects on the physical properties of granular fertilizers are not conducive to long storage times and the rigors of farm delivery equipment. Oils have been added to fertilizers as dust suppressants for some time. It was reported in a publication entitled “Fugitive Dust Control for Phosphate Fertilizer: Final Report,” Florida Institute of Phosphate Research Publication 1-015-069:136 p. (available at https://doi.org/01-015-069) to Lundgren, D. A. et al. (1988) (hereinafter “Lundgren”) that most of the oils tested on triple superphosphate (“TSP”) showed only some good initial dust control but increased dust release over time compared with waxes, which were excellent dust suppressants that provide long-term control of fugitive dust emissions. Lundgren also found a decrease in dust release with increasing kinematic viscosity of the applied oil, the benefit of which is unlikely for lower viscosity oils required as carriers for spray-applied coatings.

Other known micronutrient coatings applied to fertilizers are suspensions with high solids contents and poor solution heterogeneity. These suspensions are highly viscous making spray application very difficult and solids which settle to the bottom of vessels requiring scraping and vigorous stirring to re-disperse them and continuous agitation during pumping to any applicator.

### SUMMARY

Embodiments of the present disclosure are directed to a hydrophobic or superhydrophobic low-cost wax-based coating containing micronutrients for seeds and fertilizer products, such as fertilizer granules, pellets, and prills, collectively referred to herein as “granules” for efficiency, that can support a range of micronutrients together or singularly, evenly dispersed throughout the wax and which lowers the caking tendency of the seeds and granules, increases the resistance of the seeds and granules to humid conditions, and reduces fertilizer granule breakdown and dust formation. Micronutrients can be included in the coating in a readily available, slow releasing form, or a combination of both. Micronutrients may be any agriculturally acceptable compound(s) of copper, zinc, manganese, cobalt, iron, boron, molybdenum or mixtures thereof. For example these may comprise of sulphates, oxides, oxysulphates, chlorides, carbonates, hydroxides, nitrates, phosphates, stearates, acids, oxyanions and/or chelated forms. Micron and/or nano-sized micronutrients, or mixtures thereof, can be incorporated into the wax.

In one embodiment, the coating comprises one or more micronutrients mixed with melted wax and applied by warm melt dosing or spraying evenly across tumbling seeds, or fertilizer granules in the final step of fertilizer manufacture. In another embodiment, a high solids emulsion formulation can be diluted with water or an organic solvent, thoroughly mixed with the micronutrients, and sprayed onto the surface of fertilizer granules or seeds in a one-step process.

Embodiments of coatings according to the present invention may be applied to any fertilizer or seed, regardless of surface roughness or sphericity, and for fertilizer can be done at any convenient part of the fertilizer manufacturing and/or distribution process depending on the product and dispatch methods. For example, the coating can be applied on product exiting a granulation drum, drier or cooler depending on the product temperature and/or after it has been stockpiled before it is loaded on railcars or truck drum. Additionally or alternatively, it can be applied at a distribution center, and/or to a compacted fertilizer (e.g. muriate of potash) after compaction and crushing. The coating can be added to the fertilizer or seeds as a paste, a pumped viscous liquid, or sprayed as a lower viscosity coating, depending on the type of application equipment available. The viscosity of the coating can be adjusted for the desired application by dilution with solvent or water. Any chosen coating application method leads to better resistance to breakdown during storage and handling due to wax-based coatings being better equipped than other coatings to fill voids in the fertilizer or seed surface caused by surface roughness leading to better coating coverage.

The above summary is not intended to describe each illustrated embodiment or every implementation of the subject matter hereof The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a graph showing the release rate of micronutrients Zn and Mn from both sulphate and oxide forms in the wax coating on the macronutrient K fertilizer MOP in a laboratory dissolution test;

FIG. 2 shows MAP-ES co-granules with an oil-based micronutrient coating with dye tracer applied at a rate of 4 mL/100 g;

FIG. 3 shows the moisture uptake due to 80% RH conditions after 3 h for coated and uncoated fertilizers with images of uncoated macronutrients beneath illustrating varying sphericity and surface roughness;

FIG. 4 shows comparative abrasion data of three different shaped fertilizers uncoated or coated with an embodiment of the present invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

As mentioned, embodiments of the present disclosure are directed to a hydrophobic or superhydrophobic low-cost wax-based coating containing micronutrients for seeds and fertilizer products including granules, prills, and pellets. For sake of efficiency, although fertilizer products in the form of granules are referenced throughout below, it is understood that the coatings of the embodiments can also be applied to seeds, and that “granules” is used broadly to include granules (such as formed by granulation), compacted granules, pellets, and prills. The coating can comprise wax, and one or more micronutrients dispersed or suspended within the wax. In an alternative embodiment, the wax containing micronutrients is emulsified in a liquid carrier such as water and/or an organic solvent. The principal hydrophobic part of the coating is wax applied to the fertilizer at an amount of 0.1%-5% by weight wax (and emulsifier if present) of the total weight of the coated fertilizer, and more particularly, about 0.5-2% by weight wax.

The wax component can comprise any plant or chemical-based wax with a melting point between about 40° C. and about 105° C. (about 104° F. and about 221° F.). In some embodiments, the wax component can comprise candelilla wax, carnauba wax, bees wax, waxes recycled from food industries, or combinations thereof. In other embodiments, the wax component can comprise waxes from the petroleum industry, such as slack wax, paraffin, microcrystalline waxes, chemical waxes such as alkyl ketene dimer wax, mixtures of oils and waxes, or combinations thereof. In yet other embodiments, the wax component can comprise any combination of waxes listed above, and in any of a number of ratios.

The coating further comprises one or more micronutrients dispersed or suspended within the wax, and can comprise boron, copper, manganese, iron, zinc, molybdenum, cobalt, or combinations thereof. The micronutrients can be incorporated as a readily available form (e.g. readily-soluble or highly soluble compound), a slower releasing form (e.g. slowly-soluble or low solubility compound), or a combination of both to produce benefits of fast and slow nutrient release. For example, micronutrients can be present in the form of sulphates, oxides, oxysulphates, chlorides, carbonates, hydroxides, nitrates, phosphates, stearates, acids, oxyanions, chelates, or combinations thereof. In an embodiment, the coating includes a combination of two forms of sources of micronutrients, such as sulphates and oxides, or a combination of any fast release and slow release forms. The ratio of combination can be, for example, from 3:1, 2:1, 1:1, 1:2, or 1:3. In embodiments, the micronutrient is in a micro-or nano-sized micronutrients or mixtures thereof can be applied. This coating can utilize both readily available and slowly soluble compounds to produce benefits of fast and slow nutrient release. In other embodiments, additional primary nutrients (N, P, and/or K), and/or secondary nutrients (Ca, Mg, and/or S) are incorporated into the wax coating with or without micronutrients.

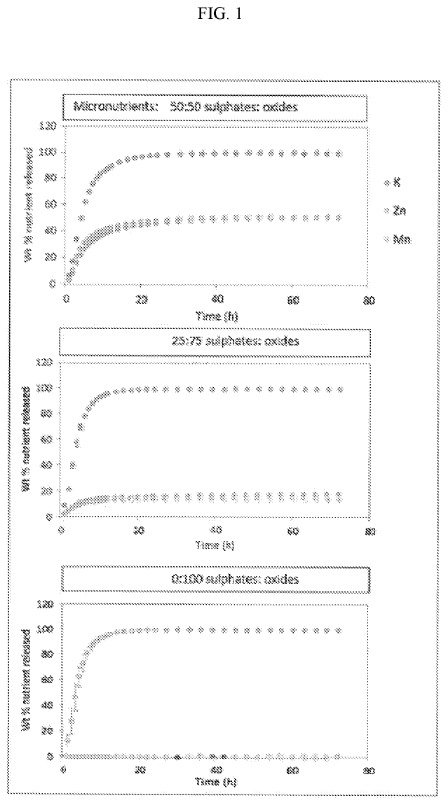

Referring to FIG. 1 the release or dissolution rate of various coatings is depicted. Three dual micronutrient-wax emulsion coatings on a muriate of potash (MOP) fertilizer in FIG. 1 were tested, each coating having a different ratio of sulphate to oxide forms of both micronutrients Zn and Mn. All products in FIG. 1 are 0.5 wt % Zn/0.5 wt % Mn coated MOP, with sulphate to oxide ratios of 50:50; 25:75; and 0:100. As shown, 50 wt % of the Mn was released after 72 h in the formulation containing equal amounts of sulphates and oxides, and 15 wt % of the Mn was released after 72 h in the formulation containing 25:75 sulphate to oxide. As shown, as the sulphate to oxide ratio decreases, the dissolution rate of the micronutrients decrease, indicating a higher solubility of the sulphate form of micronutrients than the oxide form of micronutrients.

In one embodiment, the coating comprises one or more micronutrients at about 0.01 wt % to about 10 wt % of the coating, more particularly from about 0.1 wt % to about 5 wt %, and more particularly, from about 0.5 wt % to about 2 wt % mixed with melted wax. The coating can be applied by warm melt dosing or spraying evenly across tumbling fertilizer granules at a temperature of about 50° C. and about 150° C. in a fertilizer drier/cooler during the final step of fertilizer manufacture. In other embodiments, the coating can be applied offsite, such as in a warehouse or other facility.

In other embodiments, a high solids wax emulsion (e.g. wax at an amount of 20 wt % or more of the emulsion) is made using one or more of the waxes listed above incorporating one or more micronutrients, the wax being emulsified in a carrier of water and/or an organic solvent such as isopropanol, ethanol, or acetone, whereby the wax is thoroughly mixed in the solvent carrier which will volatilize or evaporate as the coating wets out to form a hydrophobic coating on the surface of the fertilizer. The heated components, i.e. wax, micronutrients, optional emulsifier, and carrier, are combined with a high speed mixer. The wax melts when its melting temperature is reached, and is then immediately emulsified. Depending on the components, this coating can be considered superhydrophobic, meaning that the coating comprises a surface with a static contact angle higher than 150°. The static contact angle is the measured angle at which a droplet of water makes with the surface, or, in other words, how water resistant the coating surface is. In one embodiment, the emulsion can contain up to 40 wt % micronutrient containing wax, about 50 wt % or more of solvent (which works as an emulsifier). This coating can be coated onto the fertilizer granule in an amount such that the final coating is about 0.5 wt % to about 5 wt % wax, to the fertilizer granule, and more particularly about 1 to about 2 wt % wax, in addition to between about 0.1 wt % and about 1 wt % of the micronutrients, depending on an amount of micronutrient dispersed within the coating.

In one embodiment, an emulsifier, such as an oil, is added to the wax. One non-limiting example of a wax emulsifier is olive oil; however, any suitable wax emulsifier known to one of ordinary skill in art can be contemplated, such as, for example, non-ionic surfactants/detergents. Some commonly used emulsifiers can include, for example, polysorbates, cetearyl alcohol, oleates, borax, lecithin, mono-and diglycerides, or combinations thereof. In one particular embodiment, the emulsifier is added from about 0.01 to about 1.0 wt/wt % of the final coated fertilizer, more particularly about 0.1 to about 0.5 wt/wt %, and even more particularly, 0.25 wt/wt %.

In embodiments, no dispersing or suspension agents and thickener are required by this coating either as a hot melt or as an emulsion. Suspensions of micronutrients in oils require a mixture of dispersing agents, anti-settling agents and thickeners which can be compounds like fumed silica, polymerized fatty acid esters, fatty acid modified polyesters and clay which can occupy collectively as high as 5% by weight of the product. In other embodiment, dispersing or suspension agents can be incorporated into the coating composition.

Embodiments of the present disclosure can also be used in combination with one or more embodiments described in U.S. application Ser. No. 16/746,011, entitled “HYDROPHOBIC COATINGS TO IMPROVE THE PHYSICAL QUALITY PARAMETERS OF FERTILIZERS,” (“the '011 Application”) incorporated herein by reference in its entirety, and in which a rough coating or surface treatment with a low surface energy compound (such as, but not limited to, a micronutrient) is used that minimizes the effect of humidity and temperature cycling of the fertilizer and seeds for the purpose of reducing agglomeration, degradation, and dust. The coatings of the '011 Application can be used in combination with (e.g. blended or formulated together or as separated coatings) or as an alternative to the coatings described herein for seeds, fertilizer granules, prill, and pellets.

### EXAMPLES

Non-limiting embodiments of the disclosure are found in the examples below.

A 5 mL of a suspension of the wax coating composition below in Table 1 was introduced with a syringe to 200 g of muriate of potash (MOP) fertilizer and blended in a laboratory-scale drum blender for two minutes at ambient temperature (20° C.). The resulting product was evenly coated with the coating composition, and the isopropanol was driven off to leave a superhydrophobic wax and micronutrient coating containing 0.5 wt % Zn.

TABLE 1
Coating Composition

| | |
|---|---|
| Candelilla Wax | 40% by weight |
| Zinc Oxide | 11.5% by weight |
| Isopropanol | 48.5% by weight |

In another embodiment, the high solids emulsion formulation of the first example was diluted with water and was sprayed in a one-step process onto fertilizer granules at ambient temperatures. After the liquid carriers were driven off, a superhydrophobic wax and micronutrient coating containing 0.5 wt % Zn remained on the granule surface.

TABLE 2

| | |
|---|---|
| Candelilla Wax | 20% by weight |
| Zinc Oxide | 5.8% by weight |
| Isopropanol | About 25% by weight |
| Water | 50% by weight |

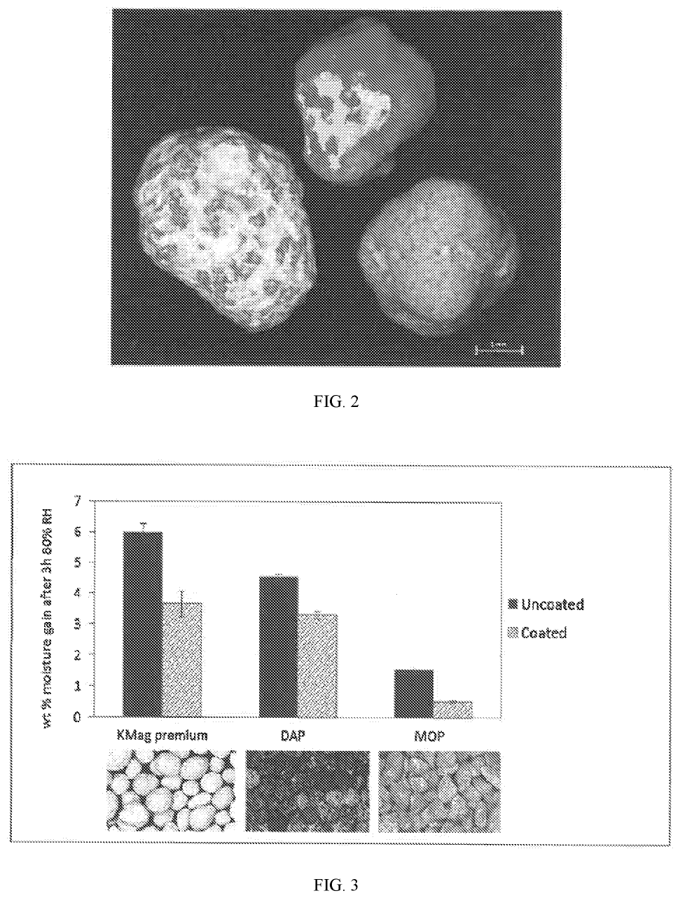

Turning now towards performance of the coatings, some macronutrient fertilizers are easier to coat than others. Granules or prills based on urea or ammonium nitrate are often more spherical, with a high surface smoothness, which makes wetting out of coatings and transfer between them during tumbling much more efficient, and the coating more evenly distributed. However, most other granular fertilizers have lower sphericity and considerably variable surface smoothness. Some examples are superphosphate, ammonium phosphates, phosphates enriched with sulfur (sulphate, elemental, or both) and/or zinc (oxide or sulphate), granulated gypsum, and compacted products such as MOP. To demonstrate the inconsistency of wetting of granules, FIG. 2 shows the coating coverage variations of an oil-based micronutrient coating of the prior art with dye tracer on monoammonium phosphate (“MAP”) plus ES (elemental sulfur) granules with varying sphericity and surface smoothness.

In the case of these granules, there is better filling of voids using wax-based coatings of embodiments of the present disclosure, which ultimately leads to better resistance to humid storage conditions, indicated by relative humidity (“RH”). For example, FIG. 3 shows the moisture uptake (wt % moisture gain) in 80% RH conditions after 3 hours for coated and uncoated fertilizers, with images of uncoated macronutrients beneath the respective portions of the chart illustrating varying sphericity and surface roughness of the granules.

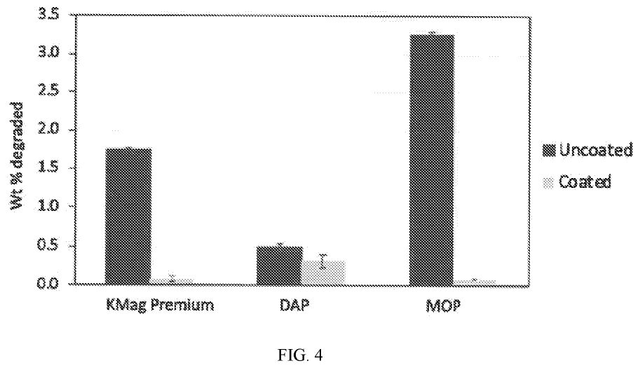

The tenacity of the coating is also of importance, given the unavoidable handling which occurs, the harshness of the equipment such as spreader equipment, and the propensity for dust generation. When the resistance to abrasion is high, there is less dust generated and any coating applied to the surface of macronutrients needs to have low surface degradation. Coatings according to embodiments of the present disclosure significantly lower the surface degradation of granules, which can be by as much as 40 times over uncoated granules, when tested in simulated harsh laboratory abrasion tests. The results of such laboratory abrasion tests are summarized in FIG. 4, which depicts comparative abrasion data for three differently shaped fertilizer granules, coated vs. uncoated. The coated granules include a wax coating that contains 0.5% Cu, 0.5% Mn, and 0.5% Zn.

Embodiments of the current disclosure provide various advantages including, for example:

Unlike wax-based coatings of the prior art, embodiments according to the present invention may be applied in single step, without the need for pre-coating or otherwise preparing the surface of the fertilizer granules for application;

The coating provides homogeneity over existing bulk blends and flexibility over micronutrient-incorporated fertilizers by ensuring micronutrients are on every granule via the ability to coat with single or multi-nutrient combinations to give formulation flexibility;

The coating provides the base granules or prills with a coated surface which is less abrasive and therefore less likely to produce dust. The presence of wax has been shown to prolong this advantage compared to low viscosity oil coatings and the wax coating strength is likely higher than for particulate micronutrient coatings which tend to be dusty.

The coating provides a layer of hydrophobic or super hydrophobic wax on the surface which is resistant to condensation during periods when the fertilizer is exposed to high humidity and cycling temperatures during storage and handling.

The coating provides the flexibility of formulating slow and fast releasing micronutrients unlike other products on the market.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A fertilizer product comprising a plurality of fertilizer granules, each granule comprising:
a base fertilizer composition containing a primary nutrient;
a micronutrient coating applied to an outer surface of the base fertilizer composition, wherein the micronutrient coating comprises a wax component and particles of a micronutrient source suspended within the wax component.

2. The fertilizer product of claim 1, wherein the wax component is selected from the group consisting of candelilla wax, carnauba wax, bees wax, waxes recycled from food industries, and combinations thereof.

3. The fertilizer product of claim 1, wherein the wax component is selected from the group consisting of slack wax, paraffin, microcrystalline waxes, alkyl ketene dimer wax, mixtures of oils and waxes, and combinations thereof

4. The fertilizer product of claim 1, wherein the micronutrient source is selected from the group consisting of boron, copper, manganese, iron, zinc, molybdenum, cobalt, and combinations thereof.

5. The fertilizer product of claim 4, wherein the micronutrient source is in form selected from the group consisting of sulphates, oxides, oxysulphates, chlorides, carbonates, hydroxides, nitrates, phosphates, stearates, acids, oxyanions, chelates, and combinations thereof.

6. The fertilizer product of claim 1, wherein the micronutrient coating further comprises a source of primary nutrient selected from the group consisting of nitrogen, phosphorus, potassium, and combinations thereof, a source of secondary nutrient selected from the group consisting of calcium, magnesium, sulfur, and combinations thereof, or both.

7. The fertilizer product of claim 1, wherein the particles of the source of micronutrient are micron-sized, nano-sized, or a combination of both.

8. The fertilizer product of claim 1, wherein the particles of the micronutrient source comprise from about 0.01 wt % to about 10 wt % of the coating.

9. The fertilizer product of claim 8, wherein the particles of the micronutrient source comprise from about 0.1 wt % to about 5 wt % of the coating.

10. The fertilizer product of claim 8, wherein the particles of the micronutrient source comprise from about 0.5 wt % to about 2 wt % of the coating.

11. The fertilizer product of claim 1, wherein the coating is in an amount of 0.1%-5% by weight of the total weight of the granule.

12. The fertilizer product of claim 1, wherein the particles of the micronutrient source comprise a combination of a sulphate form and an oxide form.

13. The fertilizer product of claim 12, wherein a ratio of the sulphate form and the oxide form is selected from 3:1, 2:1, 1:1, 1:2, and 1:3.

14. The fertilizer product of claim 1, wherein the primary nutrient is selected from the group consisting of nitrogen, phosphorus, potassium, and combinations thereof.

15. The fertilizer product of claim 14, wherein the granule further comprises elemental sulfur, sulfur in the form of sulphate, zinc oxide, zinc sulphate, or combinations thereof.

16. A method of making a micronutrient coated fertilizer or seed product, the method comprising:
providing a plurality of fertilizer granules or seeds;
coating the plurality of fertilizer granules or seeds with a micronutrient coating comprising a wax component and particles of a micronutrient source suspended within the wax component.

17. The method of claim 16, the method further comprising:
before coating the plurality of fertilizer granules or seeds, emulsifying the wax component containing the particles of micronutrient source in a liquid carrier.

18. The method of claim 17, the method further comprising:
after coating the plurality of fertilizer granules or seeds, removing the liquid carrier.

19. The method of claim 16, wherein the liquid carrier is water and/or an organic solvent.

20. The method of claim 16, wherein the organic solvent comprises isopropanol, ethanol, or acetone.

21. The method of claim 17, the micronutrient coating further comprising an emulsifier.

22. The method of claim 21, wherein the emulsifier comprises olive oil, polysorbates, cetearyl alcohol, oleates, borax, lecithin, mono-and diglycerides, or combinations thereof.

23. The method of claim 21, wherein the wax component is selected from the group consisting of candelilla wax, carnauba wax, bees wax, waxes recycled from food industries, and combinations thereof.

24. The method of claim 17, wherein the wax component is selected from the group consisting of slack wax, paraffin, microcrystalline waxes, alkyl ketene dimer wax, mixtures of oils and waxes, and combinations thereof.

25. The method of claim 17, wherein the micronutrient source is selected from the group consisting of boron, copper, manganese, iron, zinc, molybdenum, cobalt, and combinations thereof.

26. The method of claim 25, wherein the micronutrient source is in form selected from the group consisting of sulphates, oxides, oxysulphates, chlorides, carbonates, hydroxides, nitrates, phosphates, stearates, acids, oxyanions, chelates, and combinations thereof.

27-41. (canceled)
